(19) United States
(12) Patent Application Publication
(10) Pub. No.: US 2008/0285971 A1
(43) Pub. Date: Nov. 20, 2008

(54) SWITCH FOR OPTICAL INTERCONNECTION NETWORKS

(76) Inventors: Odile Liboiron-Ladouceur, Montreal (CA); Keren Bergman, Princeton, NJ (US)

Correspondence Address: BAKER BOTTS L.L.P., 30 ROCKEFELLER PLAZA, 44TH FLOOR, NEW YORK, NY, 10112-4498, US

(21) Appl. No.: 12/054,111

(22) Filed: Mar. 24, 2008

Related U.S. Application Data
(60) Provisional application No. 60/896,546, filed on Mar. 23, 2007.
(60) Provisional application No. 60/979,259, filed on Oct. 11, 2007.
(60) Provisional application No. 60/896,548, filed on Mar. 23, 2007.

(51) Int. Cl. H04J 14/00

(52) U.S. Cl. 398/45

(57) ABSTRACT

The described subject matter concerns efficient routing of data in an optical network. An optical switching element utilizes a noise reduction circuit to eliminate glitches in the optical signal, and thereby enable highly scalable, cascadeable switching networks to be constructed. The current driver is directly bonded to the SOA to reduce delays ordinarily associated with data transfer through packaging pins.

### CROSS REFERENCE TO RELATED APPLICATION

This application claims priority from U.S. Provisional Patent Application No. 60/896,546, entitled “A Bistable Switching Node For Optical Packet Switched Networks,” filed on Mar. 23, 2007 and U.S. Provisional Patent Application, 60/979,259, entitled “Optimization Of Switching Node For Optical Multistage Interconnection Networks,” filed on Oct. 11, 2007, each of which is incorporated by reference herein.

### STATEMENT REGARDING FEDERALLY SPONSORED RESEARCH

This invention was made with government support under Grant No. ECS-0322813 and Contract No. B-12-664 by the National Science Foundation and the Department of Defense, respectively. The government has certain rights in the invention.

### BACKGROUND

The present application relates to switches for optical interconnection networks.

Optical networks have long since been an attractive architecture for long haul data communications owing to their high bandwidth capacities and low communication latency characteristics. Recently, optical interconnection networks have also been demonstrated as a viable solution for parallel and distributed, high-performance computing applications.

Some optical networks perform at least a portion of the routing decisions in the electrical domain but maintain data in the optical domain to maximize the low latency and high throughput characteristics of optical transmissions. Data packets are routed from one switching element to another by converting at least a portion of the packet header to the electric domain, determining the next hop from this information, and sending an electrical signal to the appropriate optical elements to enable the optical data to flow to the next switching element.

Delays in the time between which the electric signal is sent and the optical elements are enabled can contribute to overall network latency and poorer performance. In addition, as the optical data is amplified in data transmission, existing optical noise (e.g., cross gain interference) is also amplified. The noise can cause routing errors when the noise occurs in portions of the optical data used for the routing decisions. As such, transmission errors and increased latency can result.

Accordingly, a need exists for an optimized switching element that addresses these network delays and errors.

### SUMMARY

Systems and methods for switching in optical interconnection networks are disclosed herein.

Some embodiments include a device including an optical interconnection network for routing optical data along an optical data path and including at least one optical switching element, the at least one optical switching element including an electronic routing element for making a routing decision to route the optical data to a next node in the network based at least in part on a first portion of the optical data; an optical routing element, responsive to a signal from the electronic routing element, interposed on the optical data path and, when enabled, allowing at least a second portion of the optical data to flow along the optical data path to the next node; a conversion circuit for converting a portion of the first portion of the optical data into electronic data; and a triggering circuit, coupled to the electronic routing element, adapted to mitigate fluctuations in the optical data by regenerating the portion of the first portion of the optical data, at least a portion of the first and second portions of the optical data optionally overlapping, the triggering circuit including a higher and lower output voltage level, the triggering circuit changing an output voltage of the electronic data from the higher output voltage level to the lower output voltage level when an input voltage falls below a lower threshold and changing the output voltage of the electronic data from the lower output voltage level to the higher output voltage level when the input voltage rises above an upper threshold. The triggering circuit can include a Schmitt comparator. The first portion can include header information. The network can be a vortex data network. The optical routing element can include a semiconductor optical amplifier. The at least one optical switching element can be a 2 by 2 optical switch. The device can further include a current driver integrated with an active region portion of the optical routing element for delivering a signal to enable the optical routing element.

Some embodiments include a device including an optical interconnection network for routing optical data along an optical data path and including at least one optical switching element, the at least one optical switching element including an electronic routing element for making a routing decision to route the optical data to a next node in the network based at least in part on a first portion of the optical data; an optical routing element, responsive to a signal from the electronic routing element, interposed on the optical data path and, when enabled, allowing at least a second portion of the optical data to flow along the optical data path to the next node, at least a portion of the first and second portions of the optical data optionally overlapping; and a current driver integrated with an active region portion of the optical routing element for delivering a signal to enable the optical routing element. A forward current of the current driver can be tuned to a preset gain and a small DC current can be provided to the optical routing element to maintain an appropriate carrier density.

Some embodiments include a procedure for routing optical data along an optical data path in an optical interconnection network, the optical interconnection network including at least one optical switching element, including receiving the optical data at the optical switching element; mitigating fluctuations in the optical data by regenerating a portion of a first portion of the optical data; converting the portion of the first portion of the optical data into electronic data; changing, by a triggering circuit, an output voltage of the electronic data from a higher output voltage level to a lower output voltage level when an input voltage falls below a lower threshold and changing the output voltage of the electronic data from the lower output voltage level to the higher output voltage level when the input voltage rises above an upper threshold; making a routing decision to route the optical data to a next node in the network based at least in part on the first portion of the optical data; and enabling an optical routing element to allow at least a second portion of the optical data to flow along the optical data path to the next node, at least a portion of the first and second portions of the optical data optionally overlapping. The procedure can further include delivering, by way of a current driver integrated with an active region portion of the optical routing element, a signal to enable the optical routing element.

Some embodiments include a procedure for routing optical data along an optical data path in an optical interconnection network, the optical interconnection network including at least one optical switching element, including, receiving the optical data at the optical switching element; making a routing decision to route the optical data to a next node in the network based at least in part on a first portion of the optical data; delivering, by way of a current driver integrated with an active region portion of an optical routing element, a signal to enable the optical routing element; and enabling the optical routing element to allow at least a second portion of the optical data to flow along the optical data path to the next node, at least a portion of the first and second portions of the optical data optionally overlapping.

The accompanying drawings, which are incorporated and constitute part of this disclosure, illustrate preferred embodiments of the described subject matter and serve to explain the principles of the described subject matter.

### BRIEF DESCRIPTION OF THE DRAWINGS

FIG. 1 depicts example components according to an embodiment of the described subject matter.

FIG. 2 depicts example components according to another embodiment of the described subject matter.

FIGS. 3a-3e depict example components according to yet another embodiment of the described subject matter.

FIG. 4 depicts an example device according to an embodiment of the described subject matter.

FIGS. 5a and 5b depict the optical response of an SOA (5a) and an example optical routing element (5b) of the described subject matter.

The presently described subject matter will now be described in detail with reference to the Figures in connection with the illustrative embodiments.

### DETAILED DESCRIPTION

In one embodiment, the described subject matter includes an optical switching element adapted to be used in an optical interconnection network. The optical switching element reduces the noise present in the optical data, thereby reducing routing errors, by providing a Schmitt trigger or other noise limiting circuit. A portion of routing information in a portion of optical data is converted into the electronic domain by an appropriate optical-to-electronic (“O/E”) converter. A routing decision is made in an electronic circuit, and the noise limiting circuit forms part of the routing decision. The output of the electronic routing circuit drives one or more optical routing elements to permit the optical data to flow along the appropriate optical path to the next node based at least in part on the electronic routing decision. Once the optical data has appropriately passed through the cascade of optical switching elements, it reaches its destination.

In one embodiment, the optical routing elements include semiconductor optical amplifiers (“SOA”). To reduce the guard times, and consequently increase the efficiency of the optical network, the optical switching element includes a hybrid integration of the SOA with its current driver. The current driver is bonded to the active region of the SOA. In some embodiments, the hybrid integration of the current driver with the SOA is referred to as a D-SOA. The forward current of the integrated current driver is externally tuned to a preset gain and a small DC current is provided to the D-SOA to maintain the appropriate carrier density for a faster transition time.

Optical packet switched (OPS) interconnection networks have been suggested as possible solutions for applications requiring high-capacity data routing with low communication latency. Depending on the network size, possible applications range from local area data communication and storage to high-performance computing. In multistage OPS networks, optical packets propagate through a number of cascaded switching nodes, for example, proportional to log2(N) for an N×N port network. Consequently, the node routing efficiency can impact the latency, throughput and overall scalability of the network.

In some embodiments, the switching element used in highly scalable OPS networks is the commercially available semiconductor optical amplifiers (SOA). Besides acting as a gate to route packets to their destination, the SOA compensates for optical power losses and has the ability to route wavelength division multiplexed (WDM) optical packets. One example switching element includes a 2×2 self-routing switching element containing two SOA devices as used in the data vortex network architecture. In this network topology, the node is transparent to the routed packet payload. Consequently, possible bit errors in the payload data are reversible using data encoding at the source or forward error correction at the destination. However, self-routed networks rely on error-free routing at the internal switching elements. Hence, any error in processing the routing decision can have dramatic effects on the network performance, e.g., loss of the packet and collisions with other routed packets.

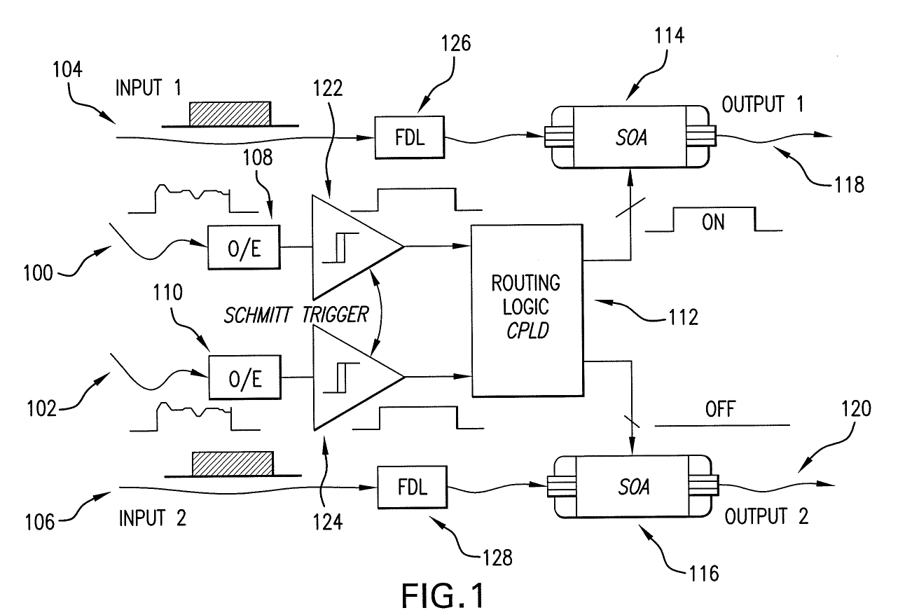

FIG. 1 depicts example components according to an embodiment of the described subject matter. The schematic shows an example 2×2 switching node for glitchless operation in accordance with one embodiment of the described subject matter. The optical switch includes optical signals 100, 102, 104, 106, 118, 120, 126, and 128. The optical data 100 and 102 is sent to optical to electrical (O/E) converters 108 and 110, respectively where the data is converted into the electrical domain. The data is then sent through Schmitt triggers 122 and 124 before being operated on by the routing logic 112. It should be noted that the glitch appearing in the optical data is corrected by the Schmitt trigger before being acted upon by the routing logic 112. Once the routing logic decision is made, the appropriate SOA is enabled. In this example, SOA 114 is enabled. In parallel with sending the optical data to the O/E converters 108 and 110, the optical data is sent through fiber delay lines (FDL) 126 and 128 to delay the data while the routing decision is made. The SOA 114 is enabled in time to allow the data exiting the FDL 126 to pass through the SOA 114. At the same time, the optical data is absorbed by the SOA 116, which remains inactive. The optical data is outputted by the outputs 118 and 120, which are associated with SOAs 114 and 116, respectively. In another example, the routing decision can enable SOA 116 to allow the optical data to pass through while absorbing the optical data in the inactive SOA 114. As the output of the Schmitt trigger 122 and 124 has removed the glitch, the signal can be regenerated without noise and reduces the possibility of noise build-up in a series of cascaded switches.

In one embodiment, in the data vortex self-routed network, the routing decision is electronically processed at the switching node level from information contained in the packet header field. Header and frame bit information are encoded along specific wavelengths within the multiple wavelength optical packet structure. Their bit value remains constant throughout the duration of the packet. The frame bit indicates the presence of a valid packet and the remaining header bits encode the destination address. At each switching node the frame and one of the header bits are filtered and converted to electrical signals.

An example optical data packet is encoded on wavelengths w₁, w₂, . . . wₙ with a frame bit encoded on wavelength w₁, a header portion encoded on wavelengths w₂ . . . wₕ, and a payload encoded on wₕ₊₁ . . . wₙ, where h<n. It should be understood that the bits can be encoded in any arbitrary order because the bits can be transmitted in parallel in the range of frequencies. Selection of any portion or any bit of the packet can be accomplished by selecting the appropriate frequency at which the portion or bit is encoded, such as by an appropriate optical filter that isolates the optical wavelength containing the bit currently being processed.

Routing is accomplished by enabling one of the two SOAs in accordance with the routing decision. In some embodiments, the switching nodes and header bits are organized such that at any given optical switching element, a bit indicates which of the possible optical paths along which the optical data should be sent to reach the next step towards the destination node.

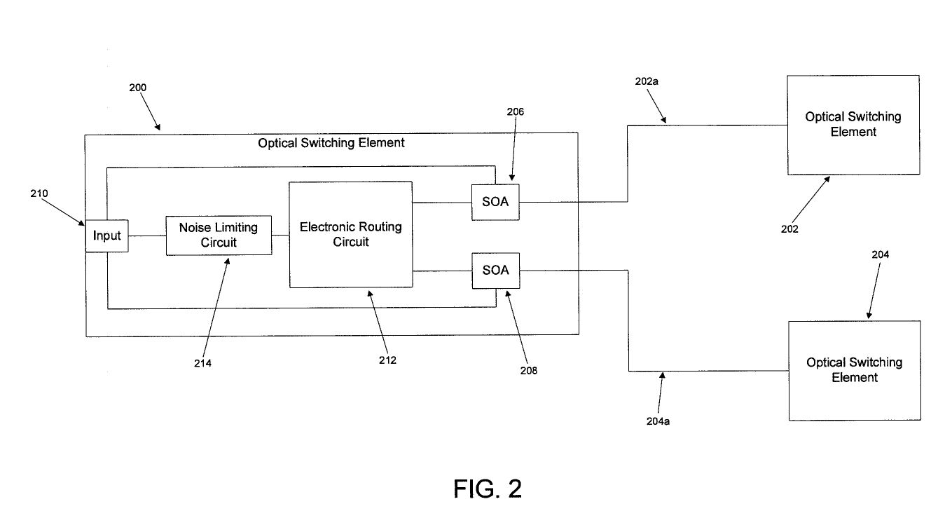

FIG. 2 depicts example components according to another embodiment of the described subject matter. An optical switching element 200 includes an input 210, an electronic routing circuit 212, and a noise limiting circuit 214, such as a Schmitt triggering circuit. The optical switching element 200 is connected to optical switching elements 202 and 204 over links 202a and 204a by way of SOAs 206 and 208, respectively.

The optical switching element 200 receives optical data, such as a data packet, on input 210. The optical data can be encoded using WDM such that all data bits are received simultaneously, encoded on different optical wavelengths. The optical data is forwarded in the optical domain to the SOAs 206 and 208, and at the same time, one or more bits are extracted by the electronic routing circuit 212 after an optical-to-electrical conversion. The data bits constitute routing data that is used to determine how to route the data to the next node, such as nodes 202 or 204, in the optical network. In some embodiments, one, two, or more optical conversion circuits convert the optical bits into electrical signals after filtering the appropriate wavelengths, depending on the number of header bits to be processed.

For example, the extracted data bits are portions of a network address of the destination node, and the routing decisions are performed on each bit of that address. In one embodiment, the routing information is processed in the order of most to least significant bit, one bit at each switching element. In this example, m optical switching elements are required for m source and destination nodes in the network. If each optical switching element includes two branches, then the number of switching elements that the optical data traverses along an optical path from a source node to a destination node is log₂(m).

Once the optical data bits are converted into electrical signals, the electrical signals are fed through a noise limiting circuit 214, such as a Schmitt trigger of a complex programmable logic device in the electronic routing circuit 212. Using the concept of hysteresis, the Schmitt trigger is able to filter out noise accumulated in the electrical signal that arises from any number of sources, such as cross gain interference, amplification, inconsistencies in the optical couplers, errors in the O/E conversion, etc. From the dual threshold action (or hysteresis) of the Schmitt trigger comparators, a noisy header signal can have a voltage value below the high threshold value, but the output signal will not go to zero unless it falls below the low threshold value. In one embodiment, the Schmitt trigger inputs of the CPLD are used with an input hysteresis threshold voltage at 80% (VT+) and 20% (VT−) of input high. When the input is between the two thresholds, the output retains its prior value for a more stable and robust node.

The output of the CPLD, which is now cleaned, is used to signal one of the optical routing elements 206 or 208 to allow the optical data to flow through to the next switching element 202 or 204. In one embodiment, at most one optical routing element 206 or 208 is active at any time. When an optical routing element 206 or 208 is active, the optical data flows through. When an optical routing element 206 or 208 is inactive, the optical data is absorbed by the optical routing element.

In order to synchronize the activation of the optical routing element 206 or 208 with the completion of the routing decision, an appropriate delay mechanism is used. In one embodiment, a fiber delay line of appropriate length is inserted between the input 210 and the optical routing elements 206 and 208 such that the optical data reaches the optical routing elements once the optical routing element 206 or 208 has been activated. Other delay techniques include slow light techniques.

In one embodiment, one or more of the optical header bits is regenerated based on the output of the noise limiting circuit such that fluctuations in the optical signal are removed. In this way, any noise accumulated from transmission from one switching element to the next successive switching element is eliminated and routing errors are reduced or eliminated. These features enable the construction of highly scalable and cascadeable optical switches, such as those used in large or very large optical interconnection networks.

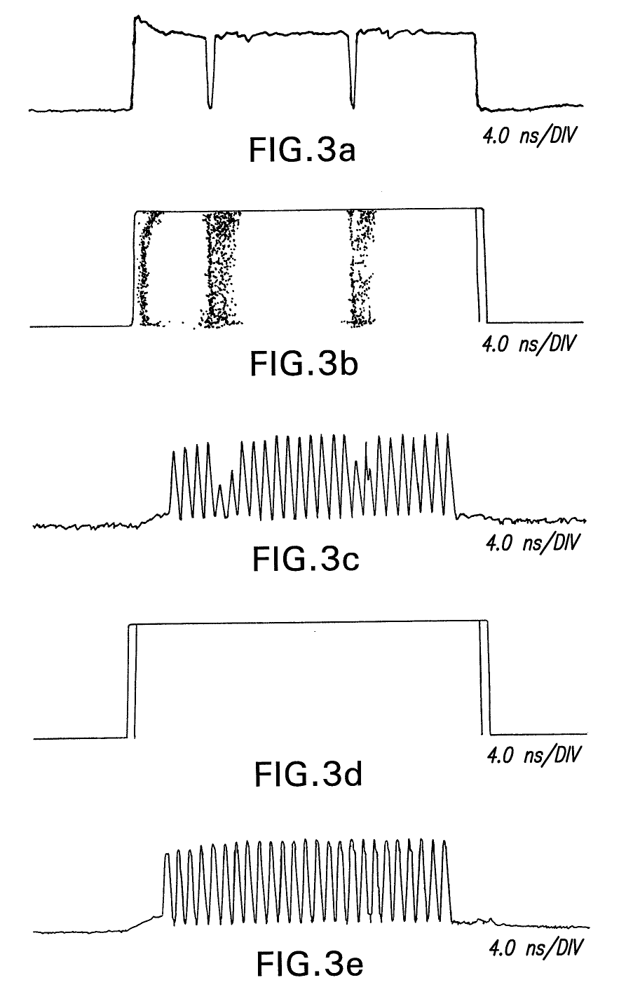

To demonstrate the efficiency of such a switching element, two glitches are induced in the optical signal incident on an example detector as shown in FIG. 3a. For this investigation, a continuous-wave (CW) DFB laser emitting at 1555.75 nm is externally modulated with a 2.5 Gb/s pattern generator to represent one of the control signals. The average optical power is −15 dBm and the minimum average power sensitivity of the detectors is −26 dBm at 155 Mb/s. The artificial glitches are created by inserting a 400 ps long digital zero at two instances in the data stream of consecutive ones. Without the Schmitt trigger comparators, the glitches propagate through the routing decision process and the driving signal to the SOA exhibit the two glitches as shown in FIG. 3b. With only one input threshold in the routing logic, the digital signal switches back and forth from a low to high when the noisy incident signal is near its threshold value. In FIG. 3c, a 2.5 Gb/s alternative bit sequence is used to demonstrate the effect of the payload of a routed packet by the falsely disabled SOA. In FIG. 3d, the Schmitt trigger comparators are enabled and the electrical routing decision signal exhibits no glitch. It should be noted that the bandwidth of the O/E conversion limits the depth of the glitch such that the signal level does not actually reach the high to low threshold voltage (VT−). With the node bistable feature, the regenerated header signal properly enables the SOA for the duration of the packet. The payload remains intact and is properly routed to subsequent nodes allowing node cascadeability and network scalability as shown in FIG. 3e. To ensure efficient bistable operation within a DC-coupled O/E signal conversion, stable extinction ratio and average optical power values can be used.

It should be noted that any number of optical inputs/outputs, SOAs, and the like can be used according to the needs of the specific implementation.

In some embodiments, the current driver for an optical routing element is bonded to the active region of the optical routing element to reduce inefficiencies and increase network throughput. Some inefficiencies of optical networks result from increased transition time between the current driver and the optical routing element. The trace signal from the current driver to the optical routing element is bandwidth limited, thereby affecting the transition time. In some instances, the transition time can be 0.9 ns.

Furthermore, in some instances, the parasitic inductance of the butterfly package pins and the capacitance load of the active region degrade the optical response of the optical routing element. Unfortunately, this transient response of the SOA directly maps to the gain affecting the payload data. An RF matching network at the cathode of the active region can help improve the optical response, but this requires tuning at every node which becomes difficult in multistage OPS networks. Consequently, the SOA optical response does not accurately map to the digital routing decision signal and the data at the leading edge of the packet can be unreliable. A larger guard time can compensate for the loss of data at the beginning of the packet, but at the cost of the overall network throughput.

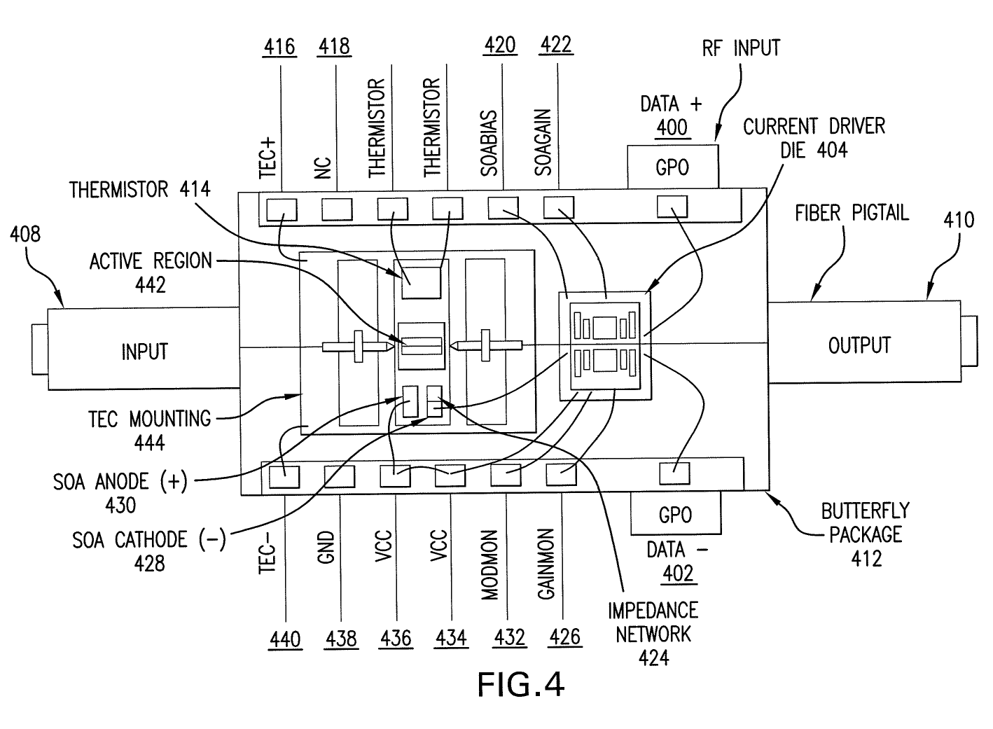

In one embodiment, the signal distortion can be reduce at the same time that the transition time is decreased by combining a current driver with the SOA device in a temperature controlled hybrid integration platform, as shown in example components of the described subject matter in FIG. 4. Inputs 400 and 402, which can be the output of routing logic, can be fed through current driver 404. The output of the current driver is sent to the active region 442 of the SOA. The output of the current driver 404, instead of being forward through a traditional pin packaging, is sent directly to the SOA input 408, thereby reducing the delays associated with transfer through pin packaging. The reduced transfer time is achieved by bonding the current driver 404 directly to the active region 442 of the SOA. Optical data entering at the input of the SOA 408 is then output through the SOA output 410 once the SOA is enabled. The current driver 404 and SOA are combined in a butterfly packaging 412. FIG. 4 further includes thermistor 414 with TEC mounting 444 and control pins TEC+ 416 and TEC− 440. The SOA pin control includes SOABIAS 420, SOAGAIN 422, GAINMON 426, MODMON 432, VCCs 434 and 436, GND 438, and an unconnected pin NC 418. The SOA further includes Impedance Network 424, Active Region 442, Anode 430, and Cathode 428,

In one embodiment, a 10.7 Gb/s current driver (MAX3934) die of 1.30 mm×1.35 mm with an integrated load-matching network is bonded to the SOA active region within a modified 28-pin butterfly package. The current driver accepts standard digital 5-Volt PECL level signal. The package has two high frequency Sub-SMB input connectors preserving the signal integrity of the differential digital logic signal that enables the optical routing element as the packet is routed through the optical switching element. Additionally, the current driver has an integrated compensation network consisting of a series-damping resistor and a shunt RC optimized for 0.4 nH inductance for the bond wire. Besides acting as a gate, the optical switching element gain compensates for small optical power losses from the passive optical components of the node structure. The current driver can inject up to 100 mA to the optical routing element which corresponds to a gain of 6 dB. The preset gain of the optical routing element is controlled by the internal current driver and is externally tuned through pin Vgain. A small DC current is provided to the optical routing element through pin Vbmon maintaining the appropriate carrier density for a faster transition time. The electrical pulse representing the routing decision generated by the CPLD is differentially fed to the optical routing element as the packet is routed through the node. Both the gain and the bias are monitored through pin Vgmon and Vbmon, respectively.

To illustrate the performance of another embodiment of the described subject matter, the optical response of the optical routing element was compared to an SOA from Kamelian (OPS-10-10-X-C-FA). Due to the bandwidth limitation of the O/E signal conversion, a 10 Gb/s capable pattern generator is programmed with a pulse representing a routing decision and fed directly to the optical routing element. In the case of the commercial SOA, the pulse is provided to an external current driver connected to the SOA device, with specified transition times of 40 ps. A CW DFB laser emitting at 1545 nm with an average optical power of −13 dBm is used to characterize the optical response of both devices. The optical routing element exhibits an input saturation power of −2 dBm and a noise figure of 7 dB compared to 0 dBm and 6.5 dB for the commercial SOA, respectively. Both devices operate in the linear regime with their gain set to 5 dB.

To further illustrate, an enhanced level of functionality is achieved by combining the current driver with the SOA in hybrid integration in one embodiment of the described subject matter. The current driver 404 is connected to the SOA active region 442 through wire bonds as shown in FIG. 4. A modified butterfly package 412 is used for optimum signal integrity. The example device takes differentially LV-PECL input signals through two RF input connectors (GPO). The gain of the SOA is controlled by the internal current driver 404 and can be externally tuned (via SOAGAIN pin 422). The SOABIAS pin 420 adds a DC current to the SOA to maintain the appropriate carrier density for faster transition time. For proper signal integrity, impedance matching components between the current driver die and the SOA cathode is added. The driving current and bias current can be monitor through the GAINMON 426 and MODMON 432 pins. Finally, the TEC and thermistor pins maintains a stable package temperature for optimum operation.

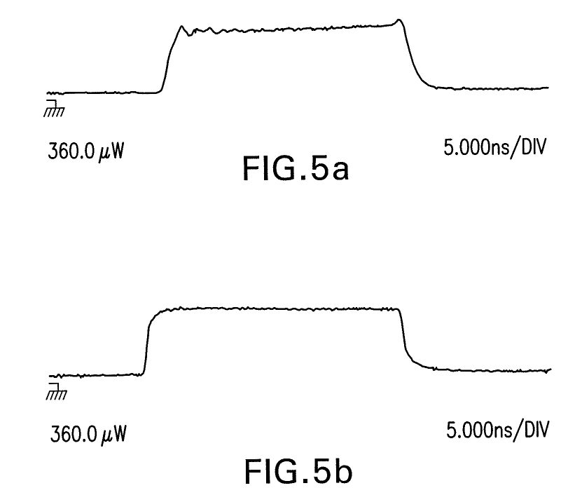

As shown in FIG. 5, two improvements are achieved with the optical routing element. First, the optical routing element exhibits improved optical transient response with less overshoot and ripples compared to the SOA. The parasitic from the package leads are eliminated in the optical routing element and the interface is better matched, mitigating possible reflection of the electrical pulse. Second, the rise and fall times of the optical routing element are 434 and 536 ps, respectively, corresponding to a 40% reduction compared to the SOA devices which have a rise and fall time of 900 ps. This improvement is in part due to the small differences in the geometry of the devices, the bandwidth of the current drives, and the differences in the saturation power which affects the transient response of the SOA. However, the improvement is, in large part, attributed to the hybrid integration approach used. The transition time improvement affects the average truncation time, resulting in a 67% increase in the number of cascaded node for the same specified guard time value.

In one embodiment, the current driver includes a Silicon-Germanium material because of the low power dissipation. In some embodiments, the current drivers are mounted directly on the PCB, which carries the electrical signals to and from the SOA sub-module and evacuates the heat generated by the current drivers.

In some embodiments, the current driver is bonded directly to the active portion of the SOA and thus becomes a part of the active region. In some embodiments, the combination of current driver and SOA constitutes an optical routing element. In other embodiments, the current driver is separate from the optical routing element (e.g., if the current driver and the SOA are connected through a pin interface.

The foregoing merely illustrates the principles of the described subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the described subject matter and are thus within the spirit and scope of the described subject matter.

1. A device including an optical interconnection network for routing optical data along an optical data path and including at least one optical switching element, the at least one optical switching element comprising:
an electronic routing element for making a routing decision to route the optical data to a next node in the network based at least in part on a first portion of the optical data;
an optical routing element, responsive to a signal from the electronic routing element, interposed on the optical data path and, when enabled, allowing at least a second portion of the optical data to flow along the optical data path to the next node;
a conversion circuit for converting a portion of the first portion of the optical data into electronic data; and
a triggering circuit, coupled to the electronic routing element, adapted to mitigate fluctuations in the optical data by regenerating the portion of the first portion of the optical data, at least a portion of the first and second portions of the optical data optionally overlapping, the triggering circuit including a higher and lower output voltage level, the triggering circuit changing an output voltage of the electronic data from the higher output voltage level to the lower output voltage level when an input voltage falls below a lower threshold and changing the output voltage of the electronic data from the lower output voltage level to the higher output voltage level when the input voltage rises above an upper threshold.

2. The device of claim 1, wherein the triggering circuit includes a Schmitt comparator.

3. The device of claim 1, wherein the first portion includes header information.

4. The device of claim 1, wherein the network is a vortex data network.

5. The device of claim 1, wherein the optical routing element includes a semiconductor optical amplifier.

6. The device of claim 1, wherein the at least one optical switching element is a 2 by 2 optical switch.

7. The device of claim 1, further comprising:
a current driver integrated with an active region portion of the optical routing element for delivering a signal to enable the optical routing element.

8. A device including an optical interconnection network for routing optical data along an optical data path and including at least one optical switching element, the at least one optical switching element comprising:
an electronic routing element for making a routing decision to route the optical data to a next node in the network based at least in part on a first portion of the optical data;
an optical routing element, responsive to a signal from the electronic routing element, interposed on the optical data path and, when enabled, allowing at least a second portion of the optical data to flow along the optical data path to the next node, at least a portion of the first and second portions of the optical data optionally overlapping; and
a current driver integrated with an active region portion of the optical routing element for delivering a signal to enable the optical routing element.

9. The device of claim 8, wherein the optical routing element includes a semiconductor optical amplifier.

10. The device of claim 8, wherein a forward current of the current driver is tuned to a preset gain and a small DC current is provided to the optical routing element to maintain an appropriate carrier density.

11. A method for routing optical data along an optical data path in an optical interconnection network, the optical interconnection network including at least one optical switching element, comprising:
receiving the optical data at the optical switching element;
mitigating fluctuations in the optical data by regenerating a portion of a first portion of the optical data;
converting the portion of the first portion of the optical data into electronic data;
changing, by a triggering circuit, an output voltage of the electronic data from a higher output voltage level to a lower output voltage level when an input voltage falls below a lower threshold and changing the output voltage of the electronic data from the lower output voltage level to the higher output voltage level when the input voltage rises above an upper threshold;
making a routing decision to route the optical data to a next node in the network based at least in part on the first portion of the optical data; and
enabling an optical routing element to allow at least a second portion of the optical data to flow along the optical data path to the next node, at least a portion of the first and second portions of the optical data optionally overlapping.

12. The method of claim 11, further comprising:
delivering, by way of a current driver integrated with an active region portion of the optical routing element, a signal to enable the optical routing element.

13. The method of claim 11, wherein the triggering circuit includes a Schmitt comparator.

14. The method of claim 11, wherein the optical routing element includes a semiconductor optical amplifier.

15. A method for routing optical data along an optical data path in an optical interconnection network, the optical interconnection network including at least one optical switching element, comprising:
receiving the optical data at the optical switching element;
making a routing decision to route the optical data to a next node in the network based at least in part on a first portion of the optical data;
delivering, by way of a current driver integrated with an active region portion of an optical routing element, a signal to enable the optical routing element; and
enabling the optical routing element to allow at least a second portion of the optical data to flow along the optical data path to the next node, at least a portion of the first and second portions of the optical data optionally overlapping.
